(19) United States
(12) Patent Application Publication
(10) Pub. No.: US 2026/0005287 A1
(43) Pub. Date: Jan. 1, 2026

(54) MANUFACTURING METHOD FOR RECHARGEABLE BATTERY

(71) Applicant: SAMSUNG SDI CO., LTD., Yongin-si, Gyeonggi-do (KR)

(72) Inventor: Jiwon YUN, Yongin-si (KR)

(21) Appl. No.: 19/209,700

(22) Filed: May 15, 2025

(30) Foreign Application Priority Data
Jun. 27, 2024 (KR) 10-2024-0084745

(51) Int. Cl. H01M 10/04; H01M 50/609

(52) U.S. Cl. CPC H01M 10/049; H01M 10/0427; H01M 10/0431; H01M 50/609

(57) ABSTRACT

A manufacturing method for a rechargeable battery includes manufacturing an electrode assembly, impregnating the electrode assembly with an electrolyte, cleaning a surface of an electrode tab of the impregnated electrode assembly, and inserting the electrode assembly into the battery can and encapsulating it.

### CROSS-REFERENCE TO RELATED APPLICATION

The present application claims priority to and the benefit of Korean Patent Application No. 10-2024-0084745, filed on Jun. 27, 2024, in the Korean Intellectual Property Office, the entire disclosure of which is incorporated herein by reference.

### BACKGROUND

### 1. Field

Aspects of embodiments of the present disclosure relate to a manufacturing method for a rechargeable battery.

### 2. Description of the Related Art

Generally, rechargeable batteries are classified into cylindrical or prismatic batteries based on whether an electrode assembly is accommodated in a cylindrical or prismatic metal can, and pouch-type batteries, in which the electrode assembly is accommodated in a pouch-type case made of an aluminum laminate sheet.

The electrode assembly accommodated in the battery case is a rechargeable power generation device including a stacked structure of anode/separator/cathode.

Electrode assemblies may be classified into a jelly roll-type structure in which a separator is interposed between long sheet-shaped positive and negative electrodes coated with active materials, a stack-type structure in which a plurality of positive and negative electrodes having a same (e.g., predetermined) size are sequentially stacked with a separator interposed therebetween, and a stack/folding type electrode assembly in which bicells or full cells in which positive and negative electrode units are stacked with a separator interposed therebetween are rolled up.

From among the types of electrode assemblies, the jelly roll-type electrode assemblies are widely manufactured because they are relatively easy to manufacture and exhibit high energy density per weight. The jelly roll-type electrode assemblies may be manufactured by assembling a stack having long sheet-shaped positive and negative electrodes and a separator interposed therebetween and winding the stack in a length direction of the sheet around a core contacting one end portion of the electrode stack.

The jelly-roll-shaped electrode assemblies may be inserted into a metal battery can, and an electrolyte is injected therein to manufacture a rechargeable battery.

However, an electrolyte shortage frequently occurs during a process of injecting the electrolyte while the electrode assembly is inserted into the battery can, which reduces stability of the battery.

### SUMMARY

Embodiments of the present disclosure provide a manufacturing method for a rechargeable battery capable of preventing an electrolyte shortage phenomenon from occurring by enabling sufficient impregnation of an electrolyte into an electrode assembly during a manufacturing process for a rechargeable battery.

A manufacturing method for a rechargeable battery, according to an embodiment of the present disclosure, includes manufacturing an electrode assembly; impregnating the electrode assembly with an electrolyte, cleaning a surface of an electrode tab of the impregnated electrode assembly, and inserting the electrode assembly into a battery can and encapsulating it.

The impregnating may include inserting the electrode assembly into an impregnation case and injecting an electrolyte into the impregnation case to impregnate the electrode assembly with the electrolyte.

The impregnation case may include a case body having an impregnation space formed therein and an injection port to inject the electrolyte into the impregnation space and a mounting portion inside the case body to mount the electrode assembly.

The mounting portion may include a mounting body inside the case body and on which the electrode assembly is to be mounted body and a guide portion protruding from the mounting body to guide installation of the electrode assembly.

The electrode assembly may be a jelly roll type electrode assembly having a through hole formed at a center thereof.

The guide portion may be an insertion projection that protrudes from the mounting body and is inserted into the through hole in the electrode assembly.

The insertion projection may protrude in a conical shape from an upper portion of the mounting body.

One of the electrode tabs of the electrode assembly may extend outside the mounting body when the electrode assembly is mounted on the mounting body.

The cleaning may include removing the electrode assembly from the impregnation case and cleaning a surface of an electrode tab of the electrode assembly.

The surface of the electrode tab may be cleaned by using a non-woven fabric.

According to an embodiment of the present disclosure, an impregnation process is performed by inserting an electrode assembly into an impregnation case and injecting an electrolyte, thereby preventing an electrolyte shortage phenomenon from occurring during the manufacturing process of a rechargeable battery and improving manufacturing quality for the rechargeable battery.

### BRIEF DESCRIPTION OF THE DRAWINGS

FIG. 1 is a schematic perspective view of a rechargeable battery according to an embodiment of the present disclosure.

FIG. 2 is a schematic perspective view of the rechargeable battery shown in FIG. 2 showing a state in which a cap plate is open.

FIG. 3 is a schematic perspective view of an electrode assembly in which a first electrode assembly and a second electrode assembly are connected according to an embodiment of the present disclosure.

FIG. 4 is a schematic flowchart describing steps of a manufacturing method for a rechargeable battery according to an embodiment of the present disclosure.

FIG. 5 is a schematic cross-sectional view of an electrode assembly positioned in a mounting portion inside an impregnation case according to an embodiment of the present disclosure.

FIG. 6 is a schematic perspective view of a mounting portion according to an embodiment of the present disclosure.

FIG. 7 is a schematic perspective view of an electrode tab cleaning operation of an electrode assembly immersed in an electrolyte according to an embodiment of the present disclosure.

FIG. 8 is a schematic perspective view of an electrode assembly is inserted into a battery can and a negative electrode tab being welded according to an embodiment of the present disclosure.

FIG. 9 is a schematic perspective view of a step of additionally injecting an electrolyte into a battery can into which an electrode assembly is inserted according to an embodiment of the present disclosure.

FIG. 10 is a schematic perspective view of insertion of an insulating sheet for welding a positive electrode tab according to an embodiment of the present disclosure.

FIG. 11 is a schematic perspective view of welding of the positive electrode tab of the electrode assembly shown in FIG. 10 to a cap plate.

FIG. 12 is a schematic perspective view of the cap plate shown in FIG. 11 being welded to a battery can.

### DETAILED DESCRIPTION

Hereinafter, the present disclosure will be described more fully with reference to the accompanying drawings, in which embodiments of the present disclosure are shown. As those skilled in the art would realize, the described embodiments may be modified in various different ways, all without departing from the spirit or scope of the present disclosure. The drawings and description are to be regarded as illustrative in nature and not restrictive.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

A rechargeable battery described below may be a button-type rechargeable battery, and may be a button-type rechargeable battery in which a diameter is longer than a height.

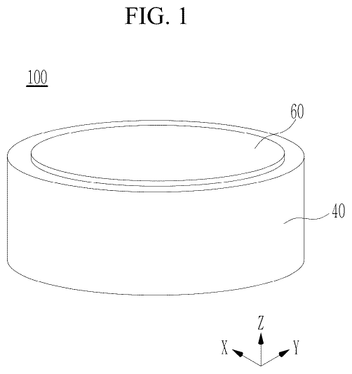

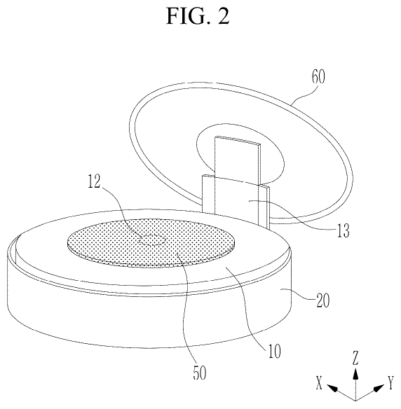

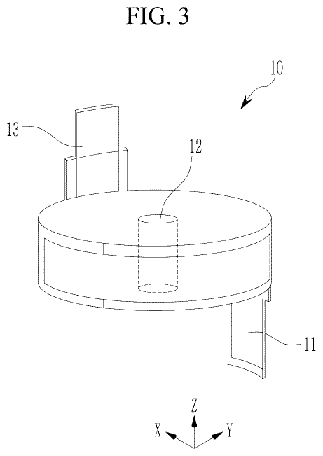

FIG. 1 is a schematic perspective view of a rechargeable battery according to an embodiment of the present disclosure, FIG. 2 is a schematic perspective view of the rechargeable battery shown in FIG. 2 in which a cap plate is open, and FIG. 3 is a schematic perspective view of an electrode assembly in which a first electrode assembly and a second electrode assembly are connected according to an embodiment of the present disclosure.

As illustrated in FIG. 1 to FIG. 3, the rechargeable battery 100, according to an embodiment of the present disclosure, may include a jelly roll-shaped electrode assembly 10, a battery can 40 having an open upper portion (or upper end) through which the electrode assembly 10 is inserted, and a cap plate 60 welded to the open upper portion of the battery can 40.

This electrode assembly 10 may be wound with have a through hole 12 in a center, and a first electrode tab 11 and a second electrode tab 13 may be connected to opposite sides thereof. The first electrode tab 11 may be a negative electrode tab, and the second electrode tab 13 may be a positive electrode tab. Hereinafter, for convenience of description, the first electrode tab and the negative electrode tab use the same reference number, and the second electrode tab and the positive electrode tab use the same reference number.

The battery can 40 may be configured to accommodate the electrode assembly 10 therein. The battery can 40 may have an internal space, and the electrode assembly 10 may be vertically inserted into this internal space. Herein, the electrode assembly 10 being inserted vertically into the battery can 40 may mean that the electrode assembly 10 is inserted such that a winding axis of the electrode assembly 10 is perpendicular to a bottom portion of the battery can 40.

The battery can 40 may have an opening at a top portion thereof. For example, the battery can 40 may have a configuration in which the top portion is open and includes a bottom portion and a side wall portion.

The battery can 40 may be made of an electrically conductive metal material, such as aluminum (Al) or stainless steel (SUS), and a shape of the battery can 40 may vary and may be, for example, a cylindrical or angled (e.g., prismatic) shape. As one embodiment of the present disclosure, a cylindrical battery can 40 will be described, in which a coiled (or rolled) electrode assembly 10 is accommodated.

The cap plate 60 may cover an upper opening of the battery can 40 and may be coupled to the battery can 40. This coupling may be performed by welding. For example, an edge of the cap plate 60 and an opening of (e.g. an open edge portion of) the battery can 40 may be coupled by laser welding.

The electrode assembly 10 may further include a first electrode tab 11 extending from a first electrode and a second electrode tab 13 extending from a second electrode.

Hereinafter, a manufacturing method for the rechargeable battery 100 described above will be described with reference to the drawings.

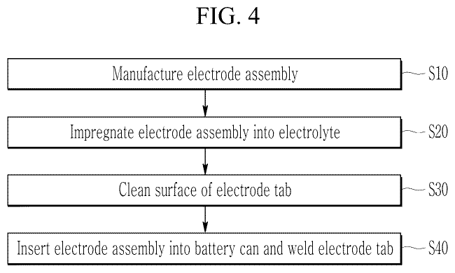

FIG. 4 is a schematic flowchart describing steps of a manufacturing method for a rechargeable battery according to an embodiment of the present disclosure. The same reference numerals as those used in FIG. 1 to FIG. 3 denote the same or similar members having the same or similar functions. Hereinafter, a manufacturing method for the rechargeable battery according to an embodiment of the present disclosure will be described in detail below.

First, an electrode assembly 10 is manufactured (S10, see, e.g., FIG. 3).

The electrode assembly 10 may be a jelly roll-type electrode assembly 10 for manufacturing a button-type rechargeable battery in which electrodes and separators are alternately arranged and wound.

Next, the electrode assembly 10 is immersed in an electrolyte (S20).

Step S20 prevents electrolyte shortages from occurring during a manufacturing process for a rechargeable battery.

For example, step S20 may include a step of inserting the electrode assembly 10 into an impregnation case 20 and a step of injecting an electrolyte into the impregnation case 20 to impregnate the electrode assembly 10 with the electrolyte.

In step S20, the electrode assembly 10 may be inserted into the impregnation case 20 for electrolyte impregnation.

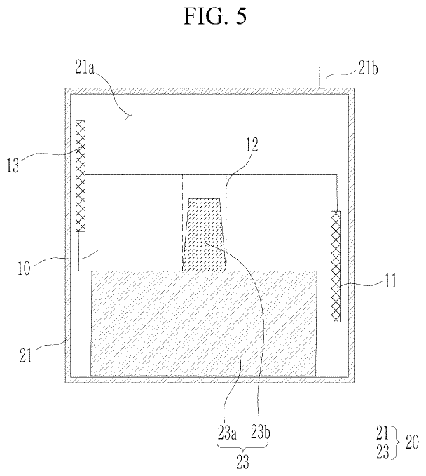

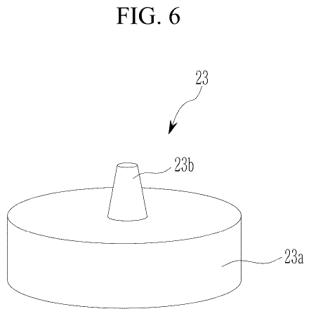

FIG. 5 is a schematic cross-sectional view of an electrode assembly positioned in a mounting portion inside an impregnation case according to an embodiment of the present disclosure, and FIG. 6 is a schematic perspective view of a mounting portion according to an embodiment of the present disclosure.

As shown in FIGS. 5 and 6, the impregnation case 20 may include a case body 21 having an impregnation space 21a formed therein and an injection port 21b formed at a first side thereof for injecting an electrolyte into the impregnation space 21a and a mounting portion 23 installed inside the case body 21 for mounting an electrode assembly 10 therein.

The case body 21 may be installed on a bottom surface of a work space and may have a cylindrical shape to ensure stable insertion and support of the jelly roll type electrode assembly 10. The case body 21 is not limited to a cylindrical shape and may be variously changed to, for example, a hexahedral shape, etc.

A mounting portion 23 for stably supporting the electrode assembly 10 during an impregnation process of the electrolyte may be installed inside the case body 21.

The mounting portion 23 may include a mounting body 23a that is installed inside the case body 21 and on which the electrode assembly 10 is mounted and a guide portion 23b that protrudes from the mounting body 23a and is inserted into the electrode assembly 10.

The mounting body 23a may support the electrode assembly 10 while inserted into the impregnation space 21a inside the case body 21.

The mounting body 23a may have a cylinder shape corresponding to a shape of the case body 21. The mounting body 23a may be changed to a shape corresponding to a change in a shape of the case body 21.

The electrode assembly 10 may be mounted in a state in which either the first electrode tab 11 or the second electrode tab 13 is extended to the outside of the mounting body 23a while being mounted on the mounting body 23a.

A guide portion 23b that guides a position at where the electrode assembly 10 is installed may protrude from an upper side of the mounting body 23a.

The guide portion 23b may guide the electrode assembly 10 to be positioned in a correct position on the upper side of the mounting body 23a when it is inserted into the case body 21.

For example, the guide portion 23b may be an insertion protrusion that protrudes from the mounting body 23a and is inserted into the through hole 12 in the electrode assembly 10. Hereinafter, the guide portion and the insertion protrusion may use a same reference number.

The insertion protrusion 23b that protrudes from the upper side of the mounting body 23a and is mounted on the mounting body 23a may be inserted into the through hole 12 formed at a center of the electrode assembly 10.

The insertion protrusion 23b may have a cone shape to be stably inserted into the through hole 12 and may protrude upwardly from the mounting body 23a.

Accordingly, the electrode assembly 10 may be regulated to a fixed position by the insertion protrusion 23b while being seated in the mounting body 23a, thereby enabling more stable seating in the mounting body 23a.

As described above, the electrode assembly 10 may be impregnated with an electrolyte injected into the impregnation space 21a while being in the case body 21 and seated on the mounting portion 23.

Accordingly, during the manufacturing process of the button-type rechargeable battery 100 according to the present embodiment, sufficient electrolyte impregnation may be possible in the electrode assembly 10, thereby preventing electrolyte shortage from occurring.

After performing step S20, surfaces of electrode tabs 11 and 13 of electrode assembly 10 may be cleaned (S30).

Step S30 may include cleaning the electrode tabs 11 and 13 including the first electrode tab 11 and the second electrode tab 13 to prevent welding defects from occurring due to foreign substances. This will be described in more detail later.

First, the electrode assembly 10 may be taken out of the impregnation case 20 and positioned in place.

In this step, the electrode assembly 10 for which an impregnation action is completed (e.g., the impregnated electrode assembly 10) may be taken out of the impregnation case 20 and positioned on a bottom portion of a work space by a positioning means (e.g., a robot arm or the like).

Next, a surface of the electrode tab of the electrode assembly 10 is cleaned.

This cleaning step may clean the first and second electrode tabs 11 and 13 to prevent welding defects from occurring.

For example, when the electrode tabs 11 and 13 of the electrode assembly 10 are exposed to air during the impregnation process of the electrode assembly 10, foreign substances, such as salt components, may be deposited on the surfaces of the electrode tabs 11 and 13 due to the electrolyte.

Accordingly, the cleaning step may remove foreign substances formed on the surfaces of the electrode tabs 11 and 13 and may prevent pinhole defects, etc. from occurring during a welding process.

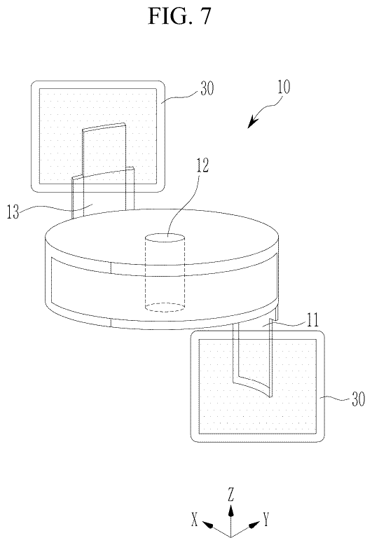

FIG. 7 is a schematic perspective view of an electrode tab cleaning operation of an electrode assembly that has been immersed in an electrolyte according to an embodiment of the present disclosure.

As shown in FIG. 7, foreign substances formed on the surfaces of the electrode tabs 11 and 13 during the impregnation of the electrolyte may be removed by using a non-woven fabric 30. The removal of foreign substances by using the non-woven fabric 30 is described as an example, and the present disclosure is not limited thereto. For example, a cleaning solution, etc. may also be used to clean the electrode tabs 11 and 13.

Next, the electrode assembly 10 may be inserted into the battery can 40, and the electrode tabs 11 and 13 may be welded (S40).

Step S40 may be to manufacture a rechargeable battery by inserting the electrode assembly 10 into the battery can 40 and encapsulating the cap plate 60, which will be described in more detail below.

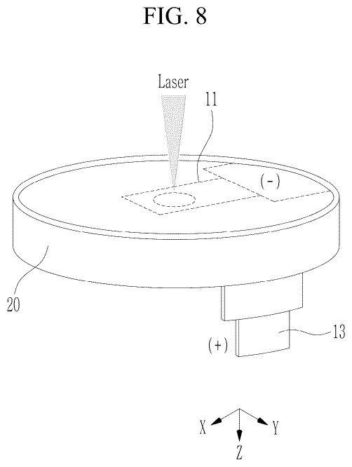

FIG. 8 is a schematic perspective view of an electrode assembly inserted into a battery can and a negative electrode tab being welded according to an embodiment of the present disclosure.

First, as shown in FIG. 8, the electrode assembly 10 may be inserted into the battery can 40 and the negative electrode tab 11 may be welded to the battery can 40. In this step, the cathode electrode tab 11 may be welded to the battery can 40 by laser welding.

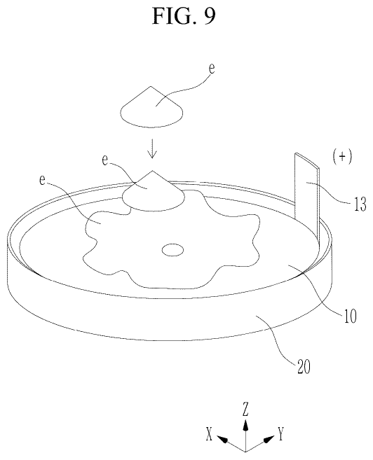

FIG. 9 is a schematic perspective view of an operation of additionally injecting an electrolyte into a battery can into which an electrode assembly is inserted according to an embodiment of the present disclosure.

Next, as shown in FIG. 9, an electrolyte may be additionally injected into the battery can 40.

This step may be used to more sufficiently inject an electrolyte into the battery can 40 to enable more effective impregnation of the electrolyte into the electrode assembly 10.

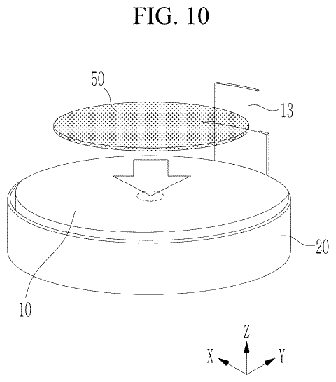

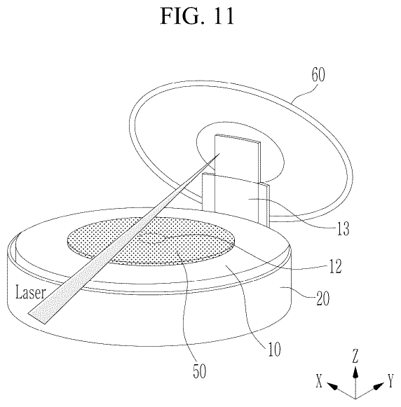

FIG. 10 is a schematic perspective view of inserting an insulating sheet for welding a positive electrode tab according to an embodiment of the present disclosure, and FIG. 11 is a schematic perspective view of welding of the positive electrode tab of the electrode assembly shown in FIG. 10 to a cap plate.

Next, as shown in FIG. 10 and FIG. 11, an insulating sheet 50 may be inserted into the battery can 40, and the positive electrode tab 13 may be welded to the cap plate 60. In this step, the positive electrode tab 13 may be welded to the cap plate 60 by laser welding.

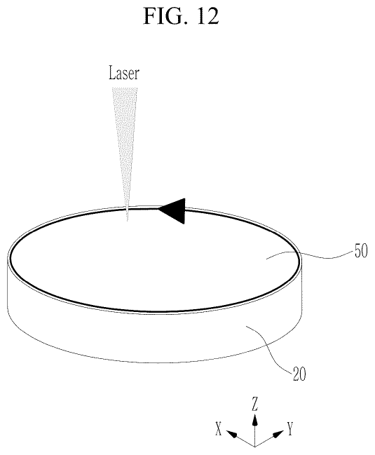

FIG. 12 is a schematic perspective view of the cap plate shown in FIG. 11 being welded to a battery can.

Next, as shown in FIG. 12, the cap plate 60 may be welded to the battery can 40, and a cleaning process may be performed to manufacture a final rechargeable battery.

In this step, the cap plate 60 may be welded to the battery can 40 by laser welding while the cap plate 60 is temporarily attached to (e.g., is pressed on) the battery can 40.

As described above, in accordance with a manufacturing method for a button-type rechargeable battery according to an embodiment of the present disclosure, by inserting the electrode assembly 10 into the impregnation case 20 and performing the process of injecting the electrolyte into the electrode assembly 10, an electrolyte shortage phenomenon may not occur during the manufacturing process for the rechargeable battery, and thus, the manufacturing quality of the rechargeable battery may be improved.

While this disclosure has been described in connection with what is presently considered to be practical embodiments, it is to be understood that the present disclosure is not limited to the disclosed embodiments, but, on the contrary, is intended to cover various modifications and equivalent arrangements included within the spirit and scope of the appended claims.

Description of Some Reference Numerals

| | | | |
|---|---|---|---|
| 10 | electrode assembly | 11 | first electrode tab (e.g., |
| | | | positive electrode tab) |
| 12 | penetration hole | | |
| 13 | second electrode tab (e.g., | | |
| | negative electrode tab) | | |
| 20 | impregnation case | 21 | case body |
| 23 | mounting portion | 23a | mounting body |
| 23b | guide portion (e.g., | | |
| | insertion protrusion) | | |
| 30 | non-woven fabric | | |
| 40 | battery can | 50 | insulating sheet |
| 60 | cap plate | | |

What is claimed is:

1. A manufacturing method for a rechargeable battery, the method comprising:
manufacturing an electrode assembly;
impregnating the electrode assembly with an electrolyte;
cleaning a surface of an electrode tab of the impregnated electrode assembly; and
inserting the electrode assembly into a battery can and encapsulating it.

2. The manufacturing method as claimed in claim 1, wherein the impregnating comprises:
inserting the electrode assembly into an impregnation case; and
injecting the electrolyte into the impregnation case and impregnating the electrode assembly with the electrolyte.

3. The manufacturing method as claimed in claim 2, wherein the impregnation case comprises:
a case body having an impregnation space formed therein and an injection port to inject the electrolyte into the impregnation space; and
a mounting portion inside the case body to mount the electrode assembly.

4. The manufacturing method as claimed in claim 3, wherein the mounting portion comprises:
a mounting body inside the case body and on which the electrode assembly is configured to be mounted; and
a guide portion protruding from the mounting body to guide installation of the electrode assembly.

5. The manufacturing method as claimed in claim 4, wherein the electrode assembly is a jelly roll electrode assembly having a through hole at a center thereof, and
wherein the guide portion is an insertion projection that protrudes from the mounting body and is inserted into the through hole in the electrode assembly.

6. The manufacturing method as claimed in claim 5, wherein the insertion projection protrudes in a conical shape from an upper portion of the mounting body.

7. The manufacturing method as claimed in claim 6, wherein one of the electrode tabs extends outside the mounting body when the electrode assembly is mounted on the mounting body in the electrode assembly.

8. The manufacturing method as claimed in claim 2, wherein the cleaning comprises:
removing the electrode assembly from the impregnation case; and
cleaning a surface of an electrode tab of the electrode assembly after it is removed from the impregnation case.

9. The manufacturing method as claimed in claim 8, wherein the cleaning of the surface of the electrode tab comprises using a non-woven fabric to clean the surface of the electrode tab.
